(19) United States
(12) Patent Application Publication
(10) Pub. No.: US 2009/0085917 A1
(43) Pub. Date: Apr. 2, 2009

(54) VARIABLE AND EVENT ASSOCIATION ON A DISPLAY

(76) Inventors: Bruce Gordon Fuller, Edmonton (CA); Brian Alexander Wall, White Rock (CA); Kevin George Gordon, Vancouver (CA); Mark David Hobbs, Hartford, WI (US); Mohamed Salehmohamed, Surrey (CA)

Correspondence Address: ROCKWELL AUTOMATION, INC/SR, 1202 SOUTH SECOND STREET, MAIL STOP E-7F19, MILWAUKEE, WI, 53204, US

(21) Appl. No.: 11/864,531

(22) Filed: Sep. 28, 2007

(51) Int. Cl. G06T 11/20

(52) U.S. Cl. 345/440.1; 345/440

(57) ABSTRACT

A method is provided for associating a variable and an event on a display. The variable is displayed relative to a time period on the display, resulting in a graph of the variable. A user input is received indicating a portion of the time period. A determination is made if the event occurred during the time period portion indicated by way of the user input. If the event occurred during the indicated portion of the time period, the event is displayed on the display.

### TECHNICAL FIELD

The invention is related to the field of industrial automation, and in particular, variable and event association on a display.

### TECHNICAL BACKGROUND

Industrial processes, such as petroleum refining, water treatment, materials manufacturing, and the like, often require constant monitoring of one or more process variables to ensure the process is performing as expected or desired. Such variables may include, for example, pressure, temperature, and flow rate of a liquid or gas being transferred in a conduit. In addition, review or analysis of process variable values previously captured during an industrial process may be undertaken to determine whether the process is being performed within predefined limits, or to discover the cause of unexpected or undesirable results of the process. Such analysis typically involves reviewing the various values of one or more process variables captured over a period of time to identify anomalies or other unanticipated behavior in the process.

In many scenarios, the value of a particular process variable is captured by way of a sensor, such as a thermal or pressure sensor. In some instances, the various captured values of a process variable may be plotted versus time as a graph on a display device, such as a computer monitor. In other implementations, the captured values may be viewed as a table of values, with each value being correlated with an indication of the time at which the value was captured.

Oftentimes, pronounced changes in a process variable may be related to a particular “event,” like the action of a specific piece of equipment, such as a valve or boiler. For example, the closing of a valve coupled with a conduit may cause a significant rise in the pressure of a gas contained within the conduit. Similarly, activating a boiler to heat the gas in the conduit may also cause a similar rise in gas pressure. However, while any of a number of events may be related to an observed change in a process variable, identification of the particular event associated with, or responsible for, a specific change in a process variable is often important in process analysis to correct or improve that process. Typically, events are associated with a particular point in time at which the event occurred, and may be detected by one or more sensors, by the issuing of a computer-generated command initiating the event, or other means.

While one or more process variables during a specified period of time may be displayed by way of a monitor for visual analysis, along with any number of events, many of the displayed events may not be temporally related to a particular portion of the time period during which a critical process variable change occurs. Further, area on the display being utilized to provide information concerning the process variables and the events is typically limited, thus possibly forcing a reduction in the amount of information on the display.

### SUMMARY

In one embodiment, a method of associating a variable and an event on a display is provided. The variable is displayed relative to a time period on the display, thus resulting in a graph of the variable. A user input is received indicating a portion of the time period. A determination is made as to whether the event occurred during the portion of the time period. If the event occurred during the indicated portion of the time period, the event is displayed on the display. In another embodiment, a computer-readable medium is provided which includes instructions executable on a processor to implement the above method.

In another embodiment, a computer system is provided which includes a display, a user interface, and a processor coupled with the display and the user interface. The user interface is configured to receive a user input. The processor is configured to display a variable relative to a time period on the display to yield a graph of the variable. The processor is also configured to receive the user input from the user interface, wherein the user input indicates a portion of the time period. Further, the processor is configured to determine if an event occurred during the portion of the time period, and, if so, to display the event on the display.

Additional embodiments and advantages of the present invention will be ascertained by those skilled in the art upon perusal of the following detailed description, taken in conjunction with the accompanying drawings.

### BRIEF DESCRIPTION OF THE DRAWINGS

FIG. 1 is a flow diagram of a method according to an embodiment of the invention of associating a variable and an event on a display.

FIG. 2 is a block diagram of a computer system according to an embodiment of the invention.

FIG. 3 is a block diagram of a computer system according to another embodiment of the invention.

FIG. 4 is a view of a display illustrating a graph of a variable versus time according to an embodiment of the invention.

FIG. 5 is a view of a display associating a graph of a variable with an event according to an embodiment of the invention.

FIG. 6 is a view of a display associating a graph of a variable with an event and a second variable according to an embodiment of the invention.

FIG. 7 is a view of a display associating a graph of a variable with a third variable according to an embodiment of the invention.

FIG. 8 is a view of a display associating a graph of a variable with a second variable when the first variable exceeds a threshold, along with a third variable, according to an embodiment of the invention.

FIG. 9 is a view of a display associating a graph of a variable with other data according to an embodiment of the invention.

### DETAILED DESCRIPTION

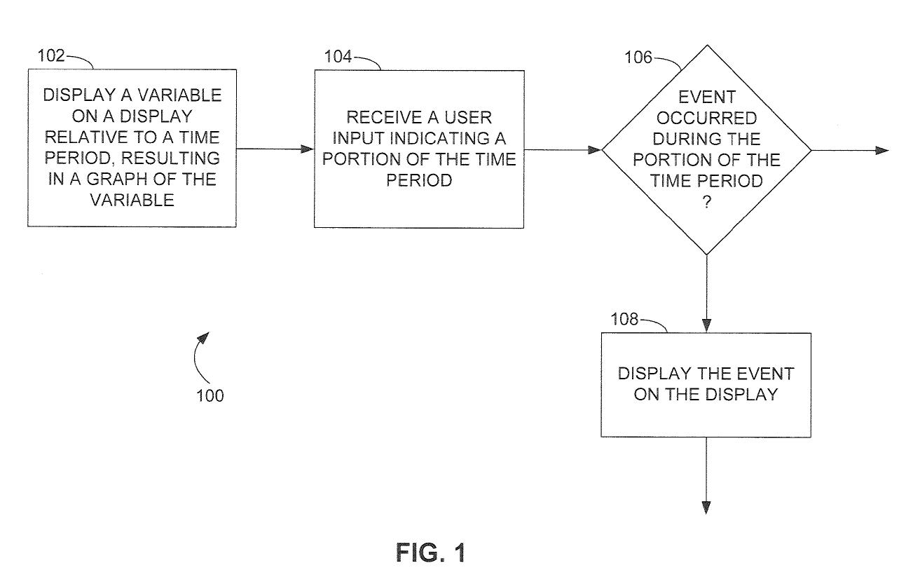

FIG. 1 provides a flow diagram of a method 100 according to an embodiment of the invention for associating a variable with an event on a display. In the method 100, the variable is displayed on the display relative to a time period, resulting in a graph of the variable (operation 102). A user input in received which indicates a portion of the time period (operation 104). If the event is determined to have occurred during the indicated portion of the time period (operation 106), the event is displayed on the display (operation 108). Another embodiment provides for a computer-readable medium comprising instructions executable on a processor for employing the method 100.

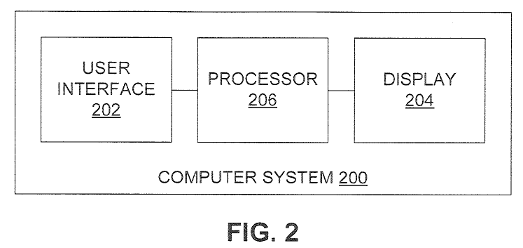

FIG. 2 depicts a computer system 200 according to another embodiment of the invention. The computer system 200 includes a user interface 202, a display 204, and a processor 206 coupled with the user interface 202 and the display 204. The user interface 202 is configured to receive a user input. The processor 206 is configured to display a variable relative to a time period on the display 204 to yield a graph of the variable. The processor 206 is also configured to receive the user input from the user interface 202, wherein the user input indicates a portion of the time period. The processor 206 is further configured to determine if an event occurred during the portion of the time period, and, if so, to display the event on the display 204.

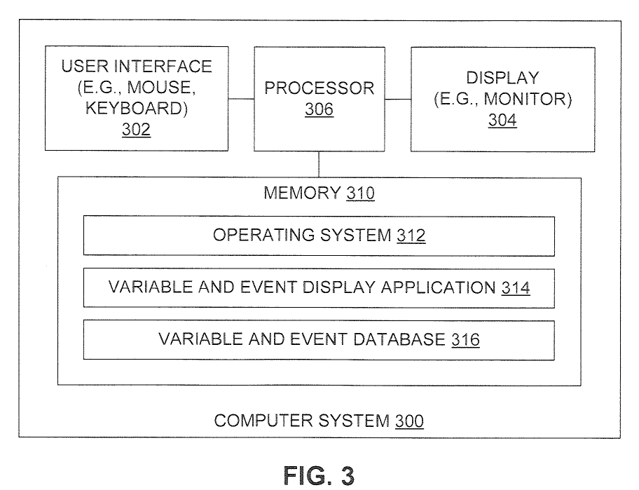

FIG. 3 provides a slightly more detailed block diagram of a computer system 300 according to another embodiment of the invention. The system 300 includes a user interface 302, a display 304, a processor 306, and a memory 310. The user interface 302 may include, for example, a keyboard along with a mouse, touchpad, joystick, or other graphical indicator device. The display 304 may be a monitor or other graphical display. Other components often associated with computer systems, such as interface ports, external media drives, and the like, are not shown to simplify the following discussion. Also, while a single computer system 300 is described herein, other systems employing multiple computers coupled together to form a distributed system may be used in other embodiments to perform the various tasks described below in connection with the computer system 300.

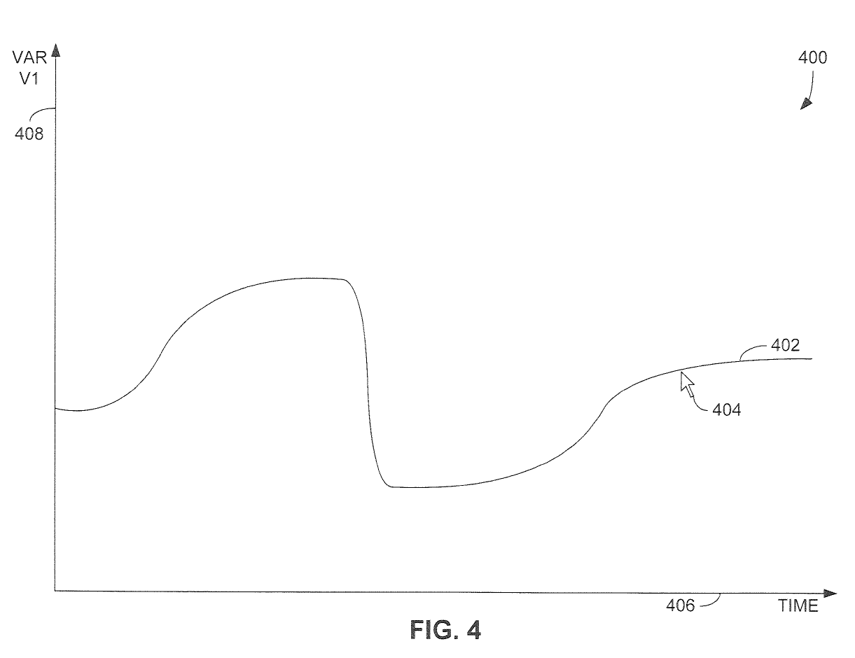

In one embodiment, the memory 310 of the system 300 may include one or more of random access memory (RAM), read-only memory (ROM), hard disk drive (HDD) memory, and other forms of memory, both volatile and nonvolatile. The memory 310 includes an operating system 312, a variable and event display application 314, and a variable and event database 316. The operating system 312 provides overall control of system 300 and allows the launching of the variable and event display application 312. The application 312, in turn, associates variables and events on the display 304, as discussed in greater detail below in conjunction with FIGS. 4-8. The variable and event database 316 contains data describing the variables and events that are to be associated on the display 304. In one embodiment, the data may be generated internally within the computer system 300, or received from one or more sources external to the computer system 300.

FIG. 4 illustrates a view 400 of a display, such as display 304 of FIG. 3, in one embodiment. In the view 400, a variable V1 is displayed relative to a time period, the extent of which may be represented by a horizontal axis 406. Similarly, a vertical axis 408 may indicate the range of possible values of the variable V1 within the time period during which the values were captured. The plot of the variable V1 results in a graph 402 of the variable versus time. While the graph 402 of FIG. 4 is drawn as a continuous graph with no discernible discontinuities, the graph 402 may be a discrete graph emphasizing some or all of the particular values of the variable V1 captured. Further, the horizontal axis 406 and the vertical axis 408 may be annotated with numerical values indicating specific time stamps and variable values associated with the graph 402. While the horizontal axis 406 and the vertical axis 408 are explicitly indicated in the view 400, the axes 406, 408 themselves may not be displayed in other implementations.

In one embodiment, the variable V1, as well as other variables described below, is a process variable associated with an industrial process. These variables may include, for example, pressure, temperature, mass, volume, and flow rate of a solid, liquid, or gas medium, such as may be found in a conduit or other container. Such variables may further include any characteristic or property of matter that potentially varies with time. In one implementation, the values of each variable are captured by sensors coupled with the process being monitored, matched with an indication of the time at which the value was captured, and stored in memory for further display and analysis. This memory may reside within a computer system, such as the variable and event database 316 of the memory 310 within the system 300 of FIG. 3, or in a memory external to the system 300 which is accessible by the processor 306. In another embodiment, the variables may not be readings of properties of an actual process, but may instead represent potential values of a theoretical process mathematically generated within a computer system, such as the system 300 of FIG. 3. Further, in other embodiments, the variables may represent any time-variant value whose value may be associated with an event, as described below.

The view 400 of FIG. 4 also displays a cursor 404 controllable by the user interface device 302, such as a mouse, touchpad, joystick, or other input device of the computer system 300. While the cursor 404 is utilized exclusively in the examples discussed below, other indicators of user input may be employed in other embodiments. For example, a point or range of the time period may be specified by way of a dialog box or other means allowing a user to input numerical values specifying the portion of the time period.

To indicate a particular portion of the time period shown in FIG. 4 using the cursor 404, a user may merely move the cursor 404 over the graph 402 at or near a portion of interest. Such an operation is typically labeled a “mouse hover,” whereby no other user operation, such as a mouse button “click” or keyboard keystroke, is required. In another embodiment, the user may position the cursor 404 over the portion of the graph 402 of interest and click. In one implementation, the user may utilize the cursor 404 to outline a selection box circumscribing the portion of the graph 402 desired. If the horizontal axis 406 is displayed, the user may instead use the selection operations described above on the horizontal axis 406 instead of the graph 402 to indicate the portion of the time period in another embodiment.

In one particular embodiment, the indicated portion of the time period may be a single point in time at which a value of the variable V1 was captured. In another example, multiple points of time at which consecutive values of the variable V1 were captured may be indicated. In yet another example, multiple noncontiguous portions of the time period may be indicated by way of multiple mouse clicks or other means. For example, the user may locate the cursor 404 over a first portion of the graph 402, click to indicate the first portion of the time period, move the cursor 404 to a second portion of the graph 402, and then click to indicate the second portion of the time period in addition to the first portion.

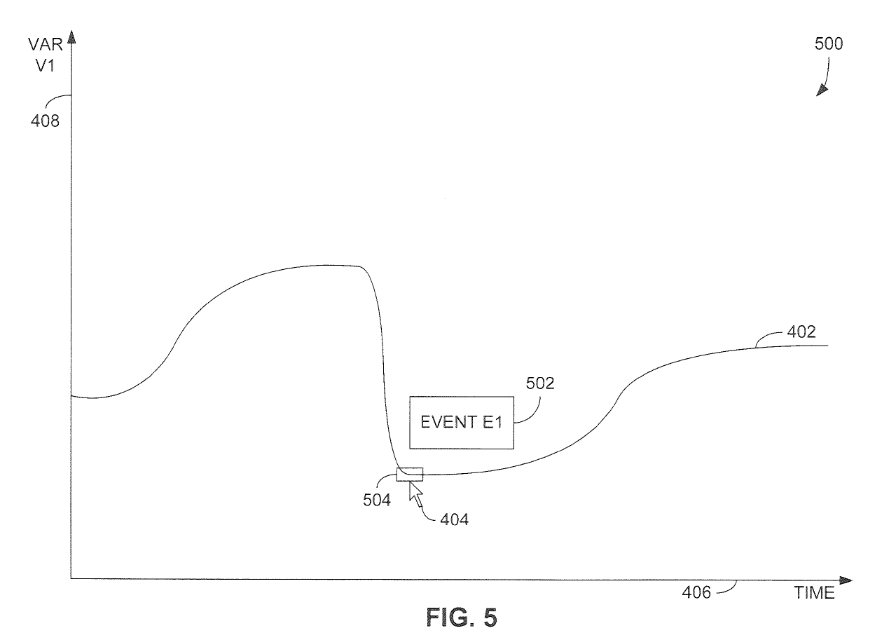

If an event occurred during the portion of the time period indicated by way of the cursor 404, the event is displayed. In the example of FIG. 4, an event is not displayed since an event did not occur in the vicinity of the portion of the time period indicated by the location of the cursor 404. In contrast, FIG. 5 provides another display view 500 which shows a different location 504 for the cursor 404 along the graph 402, resulting in displaying a representation 502 of an event E1 associated with the portion 504 of the time period indicated by the cursor 404.

The actual details of the how the event is displayed may differ from one embodiment to another. For example, the event E1 may be displayed in relative proximity to the graph 402 at the selected portion 504 of the time period, as is shown in FIG. 5. Other locations for the display 502 of the event E1 within a viewable area of the display 304 may be utilized in other implementations. Further, the display 502 of the event E1 may take the form of a text box or window, as set forth in FIG. 5. The text box may include some descriptive language regarding the nature of the event, such as “Value #1 Closed.” In other arrangements, icons and other graphical representations may be employed in addition to, or in lieu of, the textual information used in FIG. 5.

With respect to an industrial process, an event may be a specific action or operation involving a piece of equipment employed in the process, such as a valve or boiler. For example, the opening or closing of a value, or the activation of a boiler, may constitute an event. Events may also include equipment failure or any other unintended or accidental change in an industrial apparatus being employed in the process, such as the failure of a valve. Such events may also be associated with an alarm condition or the value of a particular variable exceeding above or falling below a predetermined threshold. As with process variables, events may be detected by way of a sensor. In other examples, an event may be captured by way of the operation that initiates the event, such as a command or signal to open or close a valve. More generally, an event may be any identifiable condition or operation associated with a point or limited portion of a time period.

In the embodiment of FIG. 5, a time interval, such as the portion 504 of the period of time associated with the representation 502 of the displayed event E1, may be highlighted or otherwise distinguished from the remainder of the graph 402. In one embodiment, the horizontal axis 406 may be highlighted instead of, or in addition to, the graph 402. The highlighting may occur when the cursor 404 is placed in proximity to the portion 504 of the time period associated with the event E1. In another embodiment, highlighting of the graph 402 or the horizontal axis 406 may occur before the cursor 404 is located near the associated portion of the time period, thus indicating to the user that an event of possible interest to the user is associated with that portion.

By associating one or more events with a variable on a display as described above, a user may be quickly alerted to the events identified with points of interest in a graph of a variable, such as the variable V1 graphed in FIGS. 4 and 5. In the example of FIG. 5, a user may note a point at which the variable V1 ceases to decrease rapidly and begins an increase thereafter. To determine if some event was related to the noted changes in the variable V1, the user may use a mouse or other user input interface to indicate that portion of the graph, causing the associated event to be displayed, thus correlating the event with the indicated portion of the graph. Such association of the variable with the event may thus allow the user a greater understanding as to the cause of changes in the value of the variable over a particular time period.

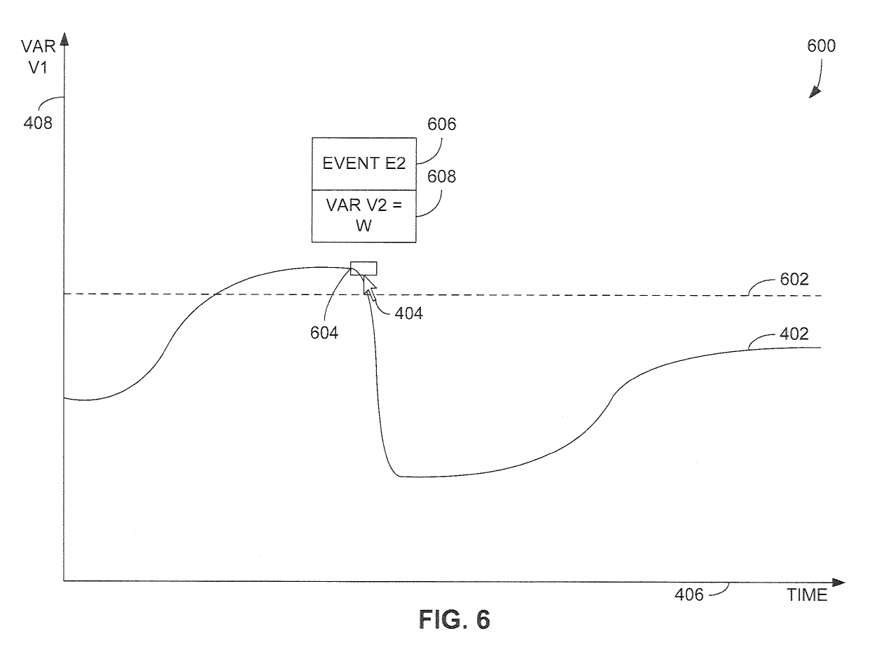

In addition to events, embodiments of the invention may also provide values of variables other than the variable V1 displayed in FIGS. 4 and 5. FIG. 6 provides a display view 600 of an example in which a representation 606 of second event E2 is displayed in connection with a second portion 604 of the graph 402 of variable V1. In addition, a value 608 of a second variable V2 captured during the second portion 604 of the time period is also displayed. In one embodiment, display of the value 608 of the second variable V2 is enabled by the value of the first variable V1 exceeding a threshold 602 during the indicated portion 604 of the time period. In contrast with FIG. 5, a value of the second variable V2 at the indicated portion 504 of the time period is not displayed because the value of variable V1 is below the threshold 602 of FIG. 6 in one implementation. While FIG. 6 indicates only a single second variable V2 being displayed in conjunction with the event E2 display 606, more or fewer variables may be displayed in conjunction with the graph 402 of the first variable V1 in other examples.

As described in greater detail below, the threshold 602 may be set by way of user input via the user interface 302 of FIG. 3. In one embodiment, the threshold 602 may be displayed on the display 304, as shown in FIG. 6, while other examples may omit an explicit display of the threshold 602.

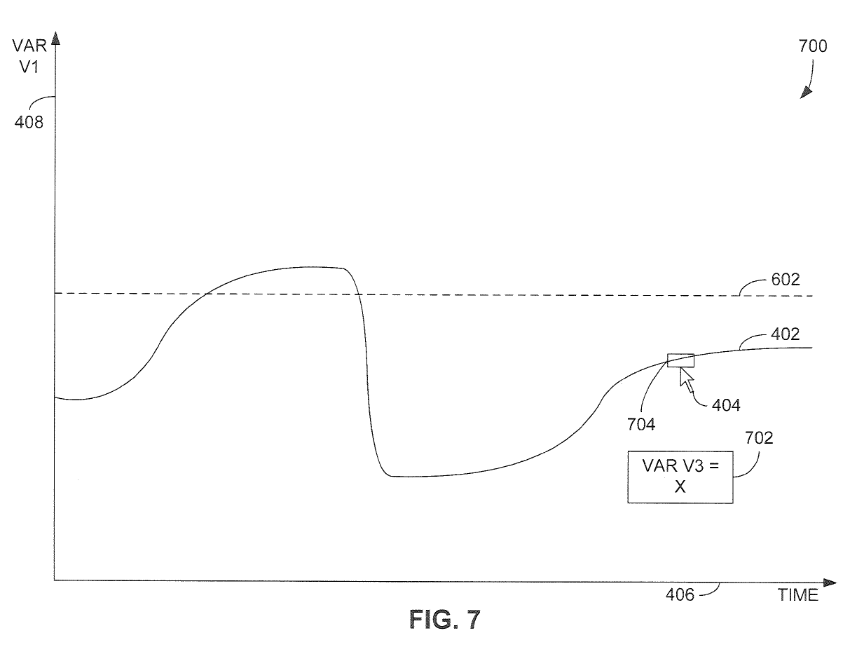

In some implementations, values of variables other than the first variable V1 may be displayed at any portion within the time period represented on the display 304, regardless of whether an event is associated with the indicated portion of the time period, and regardless of whether the first variable V1 exceeds a predetermined threshold. FIG. 7 depicts one example of a display view 700 of a third variable V3 whose value 702 associated with a portion 704 of the time period as indicated by the cursor 404 is displayed. As can be seen in FIG. 7, no event is associated with or displayed at the portion 704, and the variable V1 does not exceed the threshold 602 at the indicated time portion.

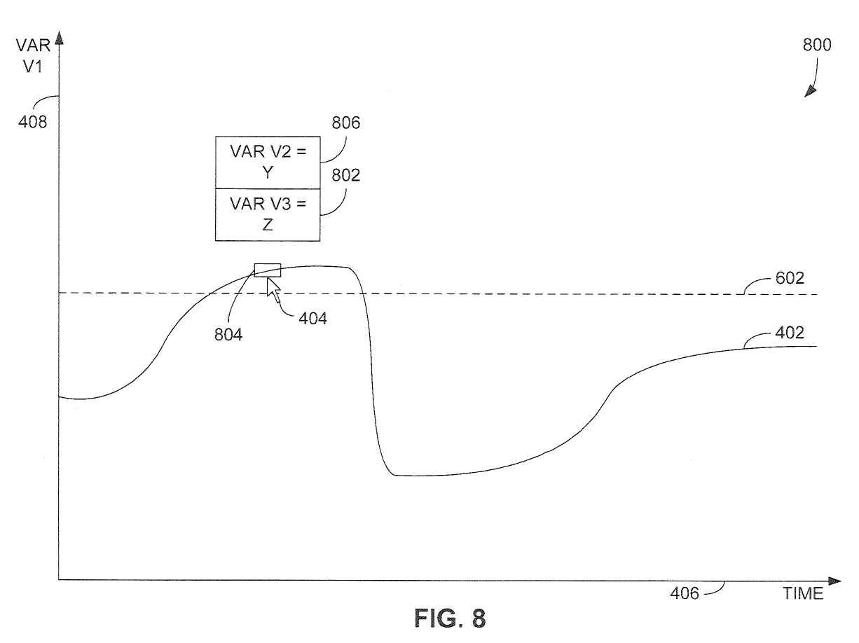

FIG. 8 provides a possible display view 800 of a related embodiment in which a different portion 804 of the time period is selected via the cursor 404. In that example, a value 802 of the third variable V3 associated with the portion 804 is displayed, along with a value 806 of the second variable V2 discussed earlier. As before, display of the value 806 of the second variable V2 is enabled as a result of the first variable V1 exceeding the threshold 602 at the indicated portion 804 of the timer period. While the values of two variables V1, V2 are displayed in FIG. 8, more or fewer variables may be displayed as required by the user in other implementations.

In various embodiments as described above, allowing the display of values of variables other than the variable being graphed (e.g., variable V1 in FIGS. 4-8) possibly supplies the user a greater understanding as to what degree the graphed variable is correlated with other variables being monitored. Further, the use of thresholds allows the value of some variables to be hidden from the user in circumstances in which the value of the hidden variable is not of particular interest to the user.

In addition to providing a more useful vehicle for the monitoring and analysis of an industrial process or other automation environment, further embodiments may provide information beneficial to Manufacturing Execution Systems/Enterprise Resource Planning (MES/ERP) functions of an organization. For example, procurement personnel may view displays similar to those provided in FIGS. 4-8 to monitor various variables or events applicable to their tasks, such as the amount of material remaining in an input holding container, or a shutdown alarm for a manufacturing process. Such information may be useful in determining the volume and timing of the purchase of a raw or manufactured material utilized in the monitored process. In another implementation, members of a sales force may use the information provided in such a display, such as a volume or quality of a process output, to ascertain the amount and timing of finished goods available for sale or shipment. Thus, the displays may provide a valuable planning tool outside the automation environment itself. Decision-making related to other MES/ERP functions may be aided by the information presented in the various embodiments described herein as well.

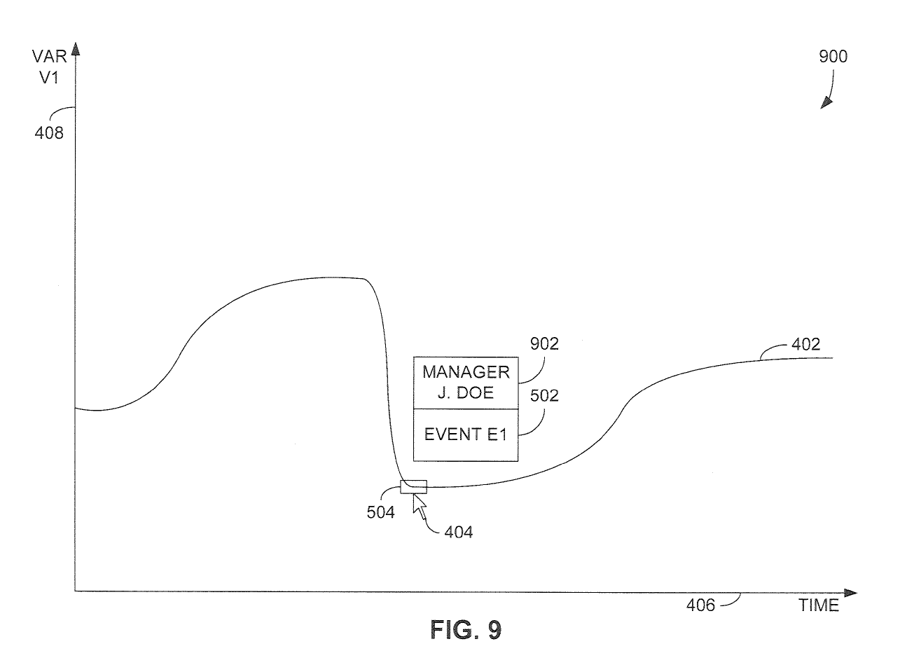

Information related to other functions of an organization, such as human resources, may be displayed and associated with a variable or event in other embodiments. In one example, an event or a particular portion of a time period associated with a variable may be displayed in conjunction with information identifying a particular employee, such as a shift manager or unit operator, associated with the specific process being analyzed or monitored. FIG. 9 provides a display view 900 in which the cursor 404 indicates the selected portion 504 of the time period from FIG. 5. In this embodiment, an identification 902 of a shift manager on duty for the monitored process at the time of the event E1 is provided in addition to the representation 502 of the event E1 itself. Other information regarding the employee, such as specific job title, experience level, contact information, and the like, may be presented to allow a user of the display to acquire data concerning the event E1 and the associated variable V1 from a person capable of providing more details regarding the circumstances of the event E1. Such information may also be utilized to improve personnel performance and job training in other implementations.

In one embodiment, the various items displayed as discussed above may be selected or preprogrammed by a user. For example, the user may select which variable is to be graphed (e.g., variable V1) and the particular time period to be graphed. The user may also select which events or types of events are to be enabled for display. For example, all events related to the opening, closing, or failure of valves may be selected. In the alternative, all events related to a particular valve or other component may be enabled in another example. In addition, a user may also specify the particular variables or types of variables to be displayed, along with any associated thresholds as described above. Further, other data not characterized as variables or events, such as personnel or human resources data possibly related to an industrial process, may be selected by a user for association with variables or events on a display.

Other aspects of how the variable and event information is displayed may also be programmable. For example, the user may be able to determine whether the graph or time axis is annotated with indications of where events have occurred, how the events, variables, and other related data are displayed, and other aspects of the displayed information. Thus, the user may tailor the display to most appropriately associate variables, events, and other data for a given application. In another example, default selections regarding various aspects of the displayed information may be provided, thus reducing the amount of user configuration required to allow the display of variables and associated events. The user selections may be provided by way of the user interface 302 of system 300 directly in connection with the variable and event display application 314. In another implementation, the user may enter the selections by way of a development tool application (not shown in FIG. 3) that is separate from the display application 314.

The above description and associated drawings teach the best mode of the invention. The following claims specify the scope of the invention. Some aspects of the best mode may not fall within the scope of the invention as specified by the claims. Also, while the preceding discussion describes embodiments employed specifically in conjunction with the monitoring and analysis of industrial processes, other applications, such as the mathematical modeling or monitoring of any man-made or naturally-existing system, may benefit from use of the concepts discussed above. Further, those skilled in the art will appreciate that the features described above can be combined in various ways to form multiple variations of the invention. As a result, the invention is not limited to the specific embodiments described above, but only by the following claims and their equivalents.

What is claimed is:

1. A method of associating a variable and an event on a display, the method comprising:
displaying the variable relative to a time period on the display, resulting in a graph of the variable;
receiving a user input indicating a portion of the time period;
determining if the event occurred during the portion of the time period; and
displaying the event on the display if the event occurred during the portion of the time period.

2. The method of claim 1, wherein the user input selects a portion of the graph to indicate the portion of the time period.

3. The method of claim 1, wherein the user input selects a portion of a time axis to indicate the portion of the time period.

4. The method of claim 1, further comprising indicating on the display a time interval during which the event occurred before receiving the user input.

5. The method of claim 1, wherein displaying the event comprises displaying a window comprising text on the display.

6. The method of claim 1, further comprising receiving a second user input before receiving the first user input, wherein the second user input enables the event to be displayed.

7. The method of claim 1, further comprising displaying a second event on the display if the second event occurred during the portion of the time period.

8. The method of claim 1, further comprising displaying a value of a second variable associated with the portion of the time period.

9. The method of claim 8, wherein the second variable is displayed if the first variable exceeds a threshold during the portion of the time period.

10. The method of claim 8, further comprising receiving a second user input indicating the threshold.

11. The method of claim 8, further comprising receiving a second user input before receiving the first user input, wherein the second user input enables the second variable to be displayed.

12. The method of claim 1, wherein the variable comprises an industrial process variable.

13. A computer-readable medium comprising instructions executable on a processor for employing a method of associating a variable and an event on a display, the method comprising:
displaying a graph of the variable over a time period on the display;
receiving a user input indicating a portion of the time period;
determining if the event occurred during the portion of the time period; and
displaying the event on the display if the event occurred during the portion of the time period.

14. The computer-readable medium of claim 13, wherein displaying the graph of the variable comprises indicating a time interval encompassing the event.

15. The computer-readable medium of claim 13, wherein the method further comprises displaying a second event on the display if the second event occurred during the portion of the time period.

16. The computer-readable medium of claim 13, wherein the method further comprises displaying a value of a second variable associated with the portion of the time period.

17. The computer-readable medium of claim 16, wherein the second variable is displayed if the first variable exceeds a threshold during the portion of the time period.

18. A computer system, comprising:
a display;
a user interface configured to receive a user input; and
a processor coupled with the display and the user interface, the processor being configured to display a variable relative to a time period on the display to yield a graph of the variable; to receive the user input from the user interface, wherein the user input indicates a portion of the time period; to determine if an event occurred during the portion of the time period; and to display the event on the display if the event occurred during the portion of the time period.

19. The computer system of claim 18, wherein the processor is further configured to indicate on the display a time interval related to the event before receiving the user input.

20. The computer system of claim 18, wherein the user interface is further configured to receive a second user input before receiving the first user input, and wherein the processor is further configured to receive the second user input from the user interface and to enable the event to be displayed in response to the second user input.

21. The computer system of claim 18, wherein the user interface is further configured to receive a second user input before receiving the first user input, and wherein the processor is further configured to receive the second user input from the user interface and to enable the second variable to be displayed in response to the second user input.
